(19) United States
(12) Patent Application Publication
(10) Pub. No.: US 2020/0380504 A1
(43) Pub. Date: Dec. 3, 2020

(54) MOBILE PAYMENT VERIFICATION

(71) Applicant: International Business Machines Corporation, Armonk, NY (US)

(72) Inventors: Yuan Hu, Beijing (CN); Yun Chen, Beijing (CN); Xiao Hai Ma, Beijing (CN); Zhi Jian Li, Beijing (CN); Yue Wang, Beijing (CN); Shan Gao, Beijing (CN)

(21) Appl. No.: 16/429,219

(22) Filed: Jun. 3, 2019

(51) Int. Cl. G06Q 20/38; G06Q 20/32

(52) U.S. Cl. CPC G06Q 20/3829; G06Q 2220/00; G06Q 20/3278

(57) ABSTRACT

This disclosure provides a computer-implemented method. In this method, a payment confirmation message is received from a second device, the payment confirmation message being obtained by the second device from a payment server and including payment-related information and first identification information. The first identification information is identified from the payment confirmation message. Second identification information is obtained from the second device through short distance communication between the first device and the second device. It is determined whether the first identification information is consistent with the second identification information. In response to the first identification information being not consistent with the second identification information, a notification is provided on the first device.

### BACKGROUND

The present disclosure relates to mobile payment, and more specifically, to a method, a system and a computer program product for mobile payment verification.

Mobile payment is a method used to facilitate the purchase of goods and services. A mobile payment may include a consumer using a mobile phone to make a payment by scanning a machine-readable code provided by a merchant. The consumer may then obtain a payment confirmation on his or her mobile phone to show the merchant to verify that the payment was made. In some cases, a notification may be provided to a device belonging to the merchant from a payment server.

Such mobile payment methods may present challenges to security and verification. For example, a consumer may present a false payment confirmation on his or her mobile phone to verify a payment, which may result in fraudulent activity that may be difficult for a merchant to detect. In another example, during periods of high payment activity, a merchant receiving notifications via a device may experience difficulty correlating the notifications with the devices from which the payments were made, which may result in delays in processing payments.

### SUMMARY

According to embodiments of the present invention, a computer-implemented method, computer system, and computer program product for processing a mobile payment is provided. In the method, a payment confirmation message is received from a second device, the payment confirmation message being obtained by the second device from a payment server and including payment-related information and first identification information. The first identification information is identified from the payment confirmation message. Second identification information is obtained from the second device through short distance communication between the first device and the second device. It is determined whether the first identification information is consistent with the second identification information. In response to the first identification information being not consistent with the second identification information, a notification is provided on the first device. The method may provide secure, convenient payment verification.

According to some embodiments of the present invention, the computer-implemented method may include the first payment confirmation message being encrypted with a first key of a key pair by the payment server and decrypting at least a part of the first payment confirmation message with a second key of the key pair. Such embodiments may provide additional security to the payment verification.

According to some embodiments of the present invention, the computer-implemented method may include receiving the first payment confirmation message through at least one of: scanning a machine-readable code presented on the second device; receiving short message communication; and receiving short distance communication between the first device and the second device. Such embodiments may provide additional security to the payment verification.

According to some embodiments of the present disclosure, the computer-implemented method may include receiving a second payment confirmation message from the second device. The second payment confirmation message may be obtained by the second device from the payment server and include second payment-related information and third identification information. The method may further include identifying the third identification information from the second payment confirmation message. The method may further include obtaining fourth identification information from the second device through short distance communication between the first device and the second device. The method may further include determining that the third identification information is consistent with the fourth identification information, and in response to the third identification information being consistent with the fourth identification information, verifying the payment by comparing at least a part of the second payment-related information with payment-related information previously stored in the first device. Such embodiments may provide additional security to the payment verification.

Other embodiments and aspects, including but not limited to, computer systems and computer program products, are described in detail herein and are considered a part of the claimed invention.

These and other features and advantages of the present invention will be described or will become apparent to those of ordinary skill in the art in view of, the following detailed description of the example embodiments of the present invention.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 shows an exemplary computer system which is applicable to implement the embodiments of the present disclosure.

FIG. 2 shows a diagram illustrating an exemplary mobile communication network which provides the framework for the embodiments of the present invention.

FIG. 3 depicts a flow chart of an example method from the perspective of a payment server for processing a mobile payment, in accordance with an embodiment of the present invention.

FIG. 4 depicts a flow chart of an example method from the perspective of a merchant terminal for mobile payment verification, in accordance with an embodiment of the present invention.

FIG. 5 depicts a cloud computing environment according to an embodiment of the present disclosure.

FIG. 6 depicts abstraction model layers according to an embodiment of the present disclosure.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Some embodiments will be described in more detail with reference to the accompanying drawings, in which the embodiments of the present disclosure have been illustrated. However, the present disclosure can be implemented in various manners, and thus should not be construed to be limited to the embodiments disclosed herein.

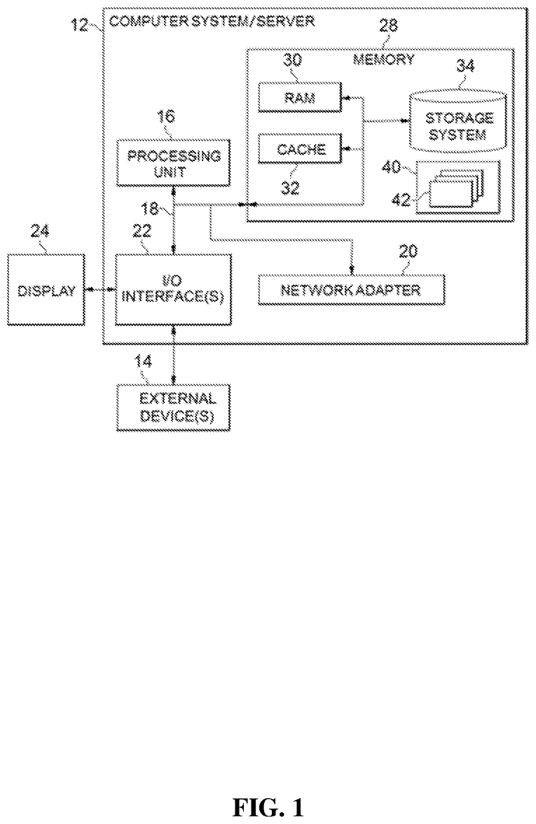

Referring now to FIG. 1, an exemplary computer system/server 12 which is applicable to implement the embodiments of the present disclosure is shown. FIG. 1 is also adapted to depict an illustrative example of a portable electronic device, such as a communication device, which is applicable to implement the embodiments of the present disclosure. Computer system/server 12 is only illustrative and is not intended to suggest any limitation as to the scope of use or functionality of embodiments of the disclosure described herein.

As shown in FIG. 1, computer system/server 12 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the disclosure as described herein.

Computer system/server 12 may also communicate with one or more external devices 14 such as a keyboard, a pointing device (e.g., a mouse), a display 24, etc.; one or more devices that enable a user to interact with computer system/server 12; and/or devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

Mobile payment is becoming more and more popular today. When a consumer needs to make a mobile payment to a merchant using a mobile phone, the merchant may request that the consumer scan a machine-readable code, such as a linear barcode or a matrix barcode, provided by the merchant to make the payment. Currently, there are several ways for the merchant to verify the payment result. For example, after the payment is completed, the consumer may receive a payment confirmation page from a payment server. The consumer may present the page shown on the consumer's mobile phone to the merchant for verification. However, such verification may not be reliable. If the consumer provides a snapshot taken on a previous payment or a false payment and shows the snapshot to the merchant, it may be difficult for the merchant to identify the false confirmation.

Another way to verify the payment result is to provide a payment notification from the payment server to the merchant's device, indicating that the payment has been completed. For example, the notification may be a payment success page shown within the merchant's payment application software, or the notification may be an audio notification to the merchant. However, the merchant's device may need to stay online to receive such notification. And if there are many payments to be made at the same time, the merchant may need to identify which notification corresponds to which payment, which may not be convenient or feasible.

Therefore, it is desirable to provide a secure and convenient approach to verifying a mobile payment. Embodiments of the present invention include a short distance communication channel to verify a mobile payment. That is, by comparing first information transmitted from the consumer to the merchant through a short distance communication channel with second information included in payment-related information presented by the consumer to the merchant, the mobile payment made by the consumer to the merchant may be verified.

By verifying a mobile payment by comparing first identification information received from a payment server and second identification information received through short distance communication, embodiments of the present invention provide enhanced security and improved convenience to mobile payment verification processes. For example, in some embodiments, such a comparison of first and second identification information may impede fraudulent payment verifications. In some embodiments, the use of short distance communication may facilitate a merchant's ability to correlate each consumer payment device with each payment notification from a payment server. In some embodiments, encrypting at least part of the first payment confirmation message with a first key of a key pair by the payment server and decrypting at least a part of the first payment confirmation message with a second key of the key pair may provide an additional level of enhanced security that may impede fraudulent activity. In some embodiments, receiving the first payment confirmation message through at least one of: scanning a machine-readable code presented on the second device; receiving short message communication; and receiving short distance communication between the first device and the second device; may provide an additional level of enhanced security that may impede the presentation of fraudulent payment verifications. In some embodiments, the comparison of second payment information with payment-related information previously stored in the first device may provide an additional level of enhanced security that may impede fraudulent reuse of payment information.

Short distance communciation technologies may provide wireless communication between devices that are separated by distances ranging from approximately 1 cm or less to approximately 50 meters or more. Short distance communication technologies may include technologies such as Near Field Communication (“NFC”), Bluetooth, ZigBee, and WiFi. For example, NFC is a set of short-range wireless technologies, typically requiring a short distance (e.g. 4 cm or less) for communicating between NFC devices. With the development of NFC technology, mobile devices have been equipped with NFC modules, which may be read by an NFC reader. For example, a consumer may initiate a payment by holding a device (e.g., a smartcard equipped with an NFC module) near an NFC reader installed in a merchant's device.

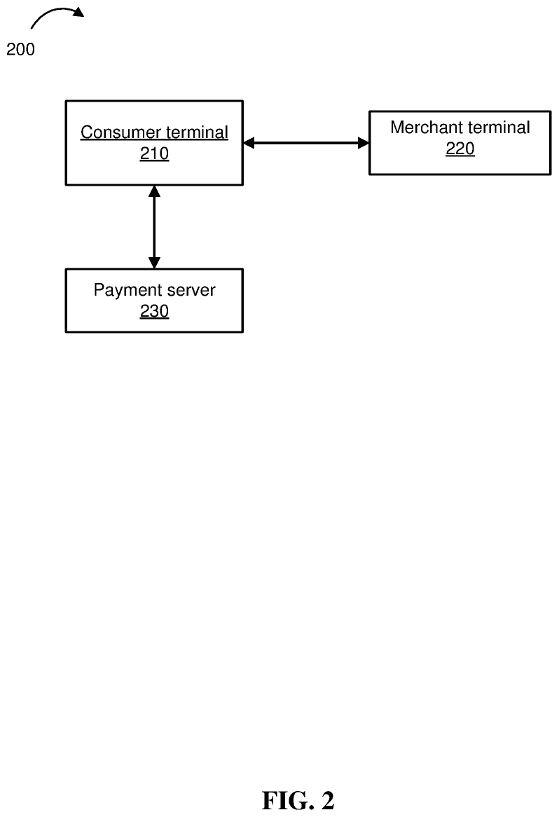

FIG. 2 depicts a schematic block diagram of a system 200 by which a method in accordance with one or more embodiments of the present invention may be implemented. In one or more embodiments of the present invention, one or more of the modules and elements shown in FIG. 2 may be omitted, repeated, and/or substituted. Accordingly, embodiments of the present invention should not be considered limited to the specific arrangements of modules shown in FIG. 2.

As shown in FIG. 2, the system 200 includes a consumer terminal 210, a merchant terminal 220 and a payment server 230. The terms “consumer terminal”, “merchant terminal”, “payment server” are used for descriptive purpose only and reference numbers 210, 220, 230 may refer to any device with appropriate functions as described herein. In the context of the embodiments of the present invention, the term “consumer” is used to refer to an entity that may need to make a payment, that is, a payer, and the term “merchant” is used to refer to an entity that may need to receive a payment, that is, a payee.

The consumer terminal 210 may be a mobile device with mobile payment functions. The consumer terminal 210 may include a code reader, such as a barcode reader or a camera, which may read a machine-readable code that is provided by the merchant for making a payment. The consumer terminal 210 may send a payment request to the payment server 230 requesting the payment server 230 to process the payment. The consumer terminal 210 may also receive a payment confirmation from the payment server 230. After receiving the payment result, the consumer may present the received payment confirmation page to the merchant, indicating that the payment has been made.

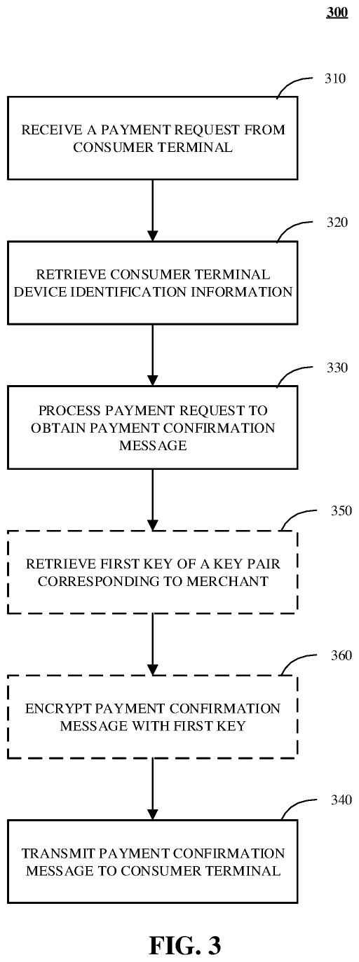

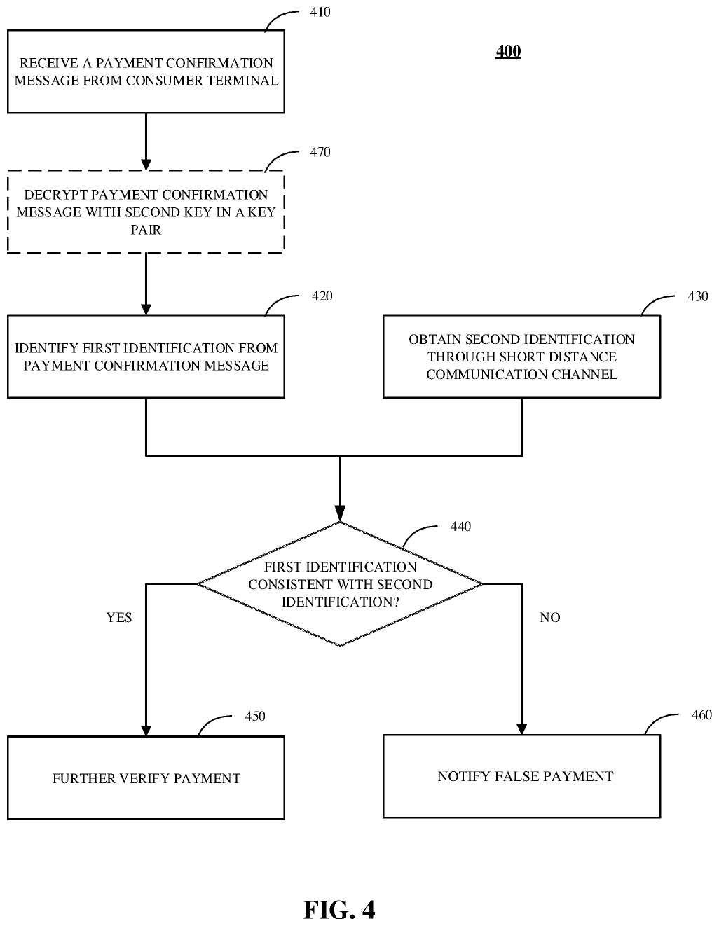

FIGS. 3 and 4 depict flowcharts of example methods in accordance with embodiments of the present invention. In one or more embodiments of the present invention, one of more of the steps shown in FIGS. 3 and 4 may be omitted, repeated, and/or performed in a different order. Accordingly, embodiments of the present invention should not be considered limited to the specific arrangements of steps shown in FIGS. 3 and 4. In one or more embodiments of the present invention, the method described in reference to FIGS. 3 and 4 may be practiced using the system 200 described in reference to FIG. 2 above. In particular, FIG. 3 depicts the method from the perspective of a payment server 230 for processing the mobile payment, while FIG. 4 depicts the method from the perspective of merchant terminal 220 for mobile payment verification.

Now a method for processing a mobile payment according to an embodiment of the present invention is described with reference to FIG. 3.

In step 310, a payment request is received from a customer terminal. The payment request may include payment-related information such as the amount of payment to be made, the consumer's identification information (for example, consumer ID), the merchant's identification information (for example, merchant ID), etc.

In step 320, device identification information of the consumer terminal is retrieved. According to an embodiment of the present invention, the device identification information may be information that uniquely identifies the consumer terminal 210. For example, it may be an International Mobile Equipment Identity (“IMEI”) number of the consumer terminal 210. In another embodiment of the present invention, the device identification information may be a NFC ID corresponding to the IMEI number of the mobile device.

According to an embodiment of the present invention, the device identification information may be retrieved from the payment request received by the payment server 230. According to another embodiment of the present invention, the device identification information of the consumer terminal 210 may be stored in the payment server 230 in advance with a mapping with the consumer ID. In such case, the device identification information may be retrieved based on the consumer ID included in the received payment request.

In step 330, the payment request is processed to obtain a payment confirmation message. Upon receiving the payment request, the payment server 230 may process the payment request according to a payment procedure. After the payment procedure is completed, a payment confirmation message is obtained. The payment confirmation message may include the device identification information retrieved in step 320. The payment confirmation message may also include payment-related information such as the amount of payment, the time of payment, the consumer ID, the merchant ID, etc. According to an embodiment of the present invention, the payment confirmation message may be in a form of a machine-readable code.

In step 340, the payment confirmation message is transmitted to the consumer terminal. In the case of the payment confirmation message being in the form of a machine-readable code, the machine-readable code would be transmitted to the consumer terminal 210 and shown on the screen of the consumer terminal 210.

According to an embodiment of the present invention, to prevent the consumer from tampering with the payment confirmation message, the payment confirmation message may be encrypted by the payment server 230 with a key of a key pair, for example, a public key in a public/private key pair. When a merchant registers with the payment server 230, the payment server 230 may assign a public/private key pair to the merchant and provide the private key of the key pair to the merchant terminal 220. The merchant terminal 220 may store the private key locally for future use. So in the method according to an embodiment of the present invention as shown in FIG. 3, in step 350, a first key of a key pair corresponding to the merchant may be retrieved by the payment server 230. For example, a merchant ID may be retrieved from the payment request received from the consumer terminal 210, and the corresponding key pair would be retrieved by the payment server 230 according to the merchant ID. In step 360, the payment confirmation message may be encrypted with the first key. And then in step 340, the encrypted payment confirmation message may be transmitted to the consumer terminal 210.

After the consumer terminal 210 receives the payment confirmation message from the payment server 230, the consumer terminal 210 may transmit the payment confirmation message to the merchant terminal 220, indicating to the merchant that the payment has been completed. The payment confirmation message may be in a form of machine-readable code, and the consumer terminal 210 may present the machine-readable code to the merchant terminal 220. The consumer terminal 210 may also transmit the payment confirmation message through short message communication (e.g., a text message) or through short distance communication between the consumer terminal 210 and the merchant terminal 220.

FIG. 4 depicts a method of processing a mobile payment according to an embodiment of the present invention from a view of the merchant terminal 220.

In step 410, a payment confirmation message is received from the consumer terminal. According to an embodiment of the present invention, the payment confirmation message is obtained by the consumer terminal 210 from the payment server 230, and includes payment-related information and first identification information. The payment-related information may include information such as the amount of payment, the time of payment, the payee ID, the payer ID, etc. The first identification information may include unique identification information of the consumer terminal 210. The payment confirmation message may be in a form of a machine-readable code.

According to an embodiment of the present invention, the merchant terminal 220 may receive the payment confirmation message by scanning the machine-readable code presented by the consumer terminal 210. According to another embodiment of the present invention, the merchant terminal 220 may receive the payment confirmation message through a short message communication. According to a further embodiment of the present invention, the merchant terminal 220 may receive the payment confirmation message through short distance communciation between the merchant terminal 220 and the consumer terminal 210, such as NFC, bluetooth, ZigBee, WiFi, etc.

In step 420, the merchant terminal 220 may identify the first identification information (e.g., unique identification information of the consumer terminal 210) from the payment confirmation message. And if the payment confirmation message has been encrypted by the payment server 230 with a first key of a key pair, before identifying the first identification information from the payment confirmation message, the merchant terminal 220 may decrypt the payment confirmation message with a second key of the key pair, as shown in step 470. According to an embodiment of the present invention, the merchant terminal 220 may retrieve the second key of the key pair which has been received from the payment server 230 and stored locally in advance.

In step 430, the merchant terminal 220 may obtain second identification information from the consumer terminal 210 through a short distance communication channel between the consumer terminal 210 and the merchant terminal 220. According to an embodiment of the present invention, the short distance communication channel is NFC. And the person skilled in the art would understand that other appropriate short distance communication technologies may also be used, including but not limited to bluetooth, ZigBee, WiFi, etc. As described earlier, the second identification information may be information that uniquely identifies the consumer terminal 210. For example, it may be an IMEI number of the consumer's mobile device. In another embodiment of the present invention, the second identification information may be a NFC ID corresponding to the IMEI number of the mobile device.

In step 440, the merchant terminal 220 may determine whether the first identification information is consistent with the second identification information. For example, in some embodiments, the first identification information may be consistent with the second identification information if the two are identical or substantially similar (e.g., each includes the same set or a substantially similar set of alphanumeric characters or symbols of an identification number or code). If YES, which means that the payment to be verified is made by the consumer terminal 210, the process goes to step 450, where the payment may be further verified. If NO, which means that the payment to be verified is not made by the consumer terminal 210, the process goes to step 460, where the merchant terminal 220 provides a false payment notification.

With the above process, a fraudulent use of a false payment confirmation message, or a message received by another consumer to present to the merchant may be identified.

To prevent the consumer from using a previous payment confirmation message for current payment, if it is determined that the first identification information is consistent with the second identification information, the process may further verify the payment with the payment-related information included in the payment confirmation message.

According to an embodiment of the present invention, for previously verified payments, the payment-related information such as transaction ID may be stored in the merchant terminal to check whether the payment confirmation message is reused. To reduce the storage space to be occupied by the previous payment-related information, such information may be temporarily stored for a period of time. The merchant terminal may compare at least a part of the payment-related information received from the consumer terminal with payment-related information previously stored in the merchant terminal. For example, the transaction ID of current payment may be compared with a list of transaction ID which has been used before and stored in the local storage. If it is found that the translation ID has been reused, a false payment may be provided on the merchant terminal.

According to another embodiment of the present invention, the payment confirmation message may include a time stamp indicating the time of the payment being made. And a time limit may be specified by the merchant terminal. After the payment confirmation message is received, the merchant terminal may determine whether the time stamp included in the payment confirmation message is within the time limit, and may provide a false payment notification if the time stamp is not within the specified time limit.

In above descriptions, NFC is used as an example of short distance communication to illustrate embodiments of the present invention. And the person skilled in the art would understand that other short distance communication technologies may be used as well, including but not limited to bluetooth, ZigBee, WiFi, etc.

Now with reference back to FIG. 2, an example process according to an embodiment of the present invention will be described.

As shown in FIG. 2, the system 200 includes a consumer terminal 210, a merchant terminal 220 and a payment server 230. The consumer terminal 210 may include a code reader, which may read a machine-readable code provided by the merchant to make a payment. The machine-readable code may include a unique identification of the merchant, for example, a merchant ID. The consumer terminal 210 may also include a payment application installed on the consumer terminal 210. The consumer terminal 210 may send a payment request to the payment server 230 requesting the payment server 230 to process the payment. Upon receiving the payment request from the consumer terminal 210, the payment server 230 may process the payment request and obtain a payment confirmation message according to the process as described with reference to FIG. 3 above.

The payment confirmation message includes consumer terminal 210's device identification information, such as a device ID of the consumer terminal 210. The payment confirmation message may be in a form which can not be tampered by the consumer terminal 210. According to an embodiment of the present invention, the payment confirmation message may be in a form of machine-readable code. Furthermore, the payment confirmation message may be encrypted by the payment server 230 with a key of a key pair. The consumer terminal 210 may have NFC function embedded. And information in the consumer terminal 210, such as a device ID of the consumer terminal 210 may be read by a NFC reader through its NFC function. According to an embodiment of the present invention, the device ID may be an IMEI number of a mobile device.

After receiving the payment confirmation message, the consumer may present the received payment confirmation message to the merchant terminal 220. According to one or more embodiments of the present invention, the merchant terminal 220 may include a code reader, which may read a machine-readable code presented by the consumer terminal 210. The machine-readable code may represent the payment confirmation page received by the consumer terminal 210 from the payment server 230. The merchant terminal 220 may identify the consumer terminal 210's device identification information from the payment confirmation message. At the same time, the merchant terminal 220 may receive device identification information from the consumer terminal 210 through a NFC channel. For example, the merchant terminal 220 may have a NFC reader, which may read NFC signal transmitted from the consumer terminal 210. The NFC signal transmitted from the consumer terminal 210 may include device identification information. The merchant terminal 220 may compare the device identification information included in the payment result with the device identification information received through its NFC reader to determine that the payment is made by the consumer terminal 210. Therefore, if the consumer shows a false payment result to the merchant, which would not include the device identification information of the consumer terminal 210, the merchant terminal 220 may provide a warning to the merchant.

As described above, the payment result may be encrypted by the payment server 230, which prevents the consumer to make change on the payment result. According to one or more embodiments of the present invention, the merchant terminal 220 may include a storage for storing information such as a public key in a key pair. The public key may be used to decrypt the payment result which has been encrypted with a private key in the key pair. The storage may also be used to store other information, such as transaction ID of previous payments. The merchant terminal 220 may decrypt the encrypted payment result with a corresponding key in the key pair and then retrieve corresponding information from the decrypted payment result.

With the embodiments of the present invention, it is convenient and effective for the merchant to verifying the payment made by a consumer. At the same time, as long as the merchant's device has stored locally the corresponding key in the key pair, there is no need to have the merchant's device staying online to verify the payment.

It should be noted that the processing of mobile payment according to embodiments of this disclosure could be implemented by computer system/server 12 of FIG. 1.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

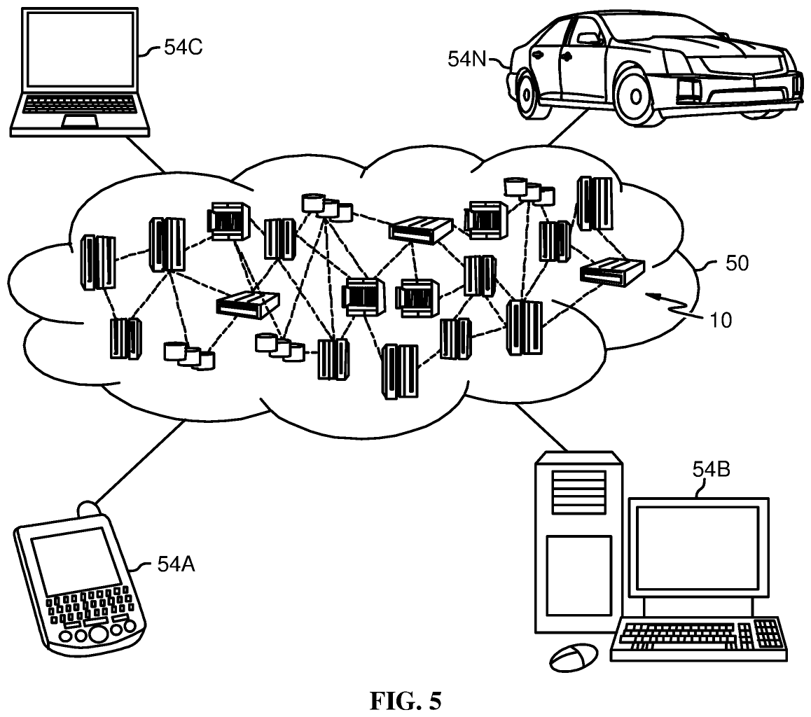

Referring now to FIG. 5, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

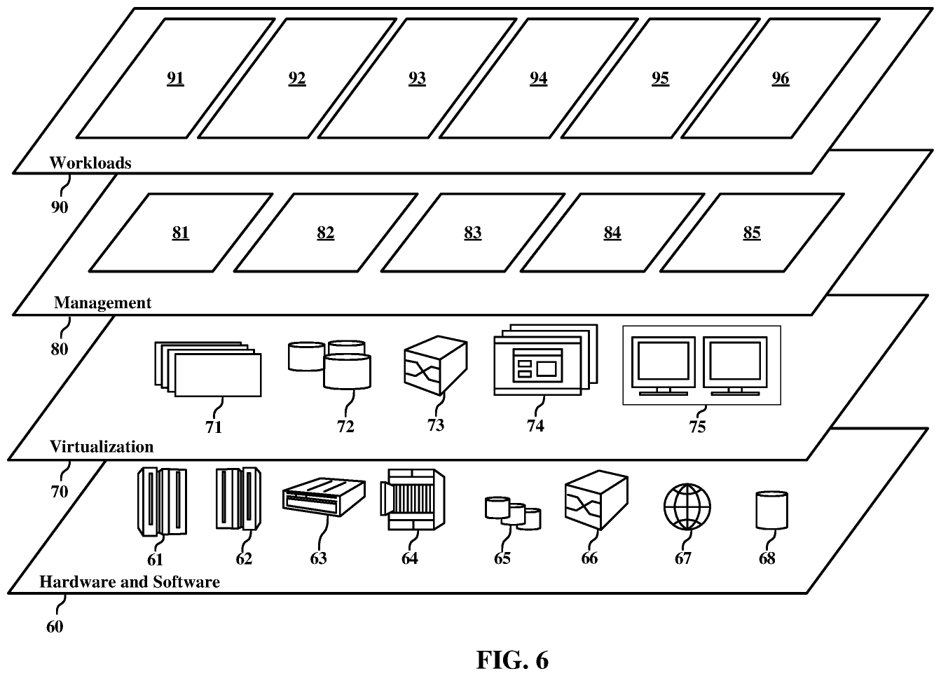

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and mobile payment logic 96.

As discussed in more detail herein, it is contemplated that some or all of the operations of some of the embodiments of methods described herein may be performed in alternative orders or may not be performed at all; furthermore, multiple operations may occur at the same time or as an internal part of a larger process.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A computer-implemented method by a first device for processing a mobile payment, the method comprising:
receiving a first payment confirmation message from a second device, the first payment confirmation message being obtained by the second device from a payment server and including first payment-related information and first identification information;
identifying the first identification information from the first payment confirmation message;
obtaining second identification information from the second device through short distance communication between the first device and the second device;
determining that the first identification information is not consistent with the second identification information; and
in response to the first identification information being not consistent with the second identification information, providing a notification on the first device.

2. The method of claim 1, wherein at least a part of the first payment confirmation message has been encrypted with a first key of a key pair by the payment server, and the method further comprises decrypting at least a part of the first payment confirmation message with a second key of the key pair.

3. The method of claim 1, wherein the first payment confirmation message is in a form of a machine-readable code.

4. The method of claim 1, wherein the receiving the first payment confirmation message from the second device includes receiving the first payment confirmation message through at least one communication medium, wherein the at least one communication medium is selected from the group consisting of: scanning a machine-readable code presented on the second device, receiving short message communication, and receiving short distance communication between the first device and the second device.

5. The method of claim 1, wherein the at least one communication medium is a Near Field Communication (NFC) channel.

6. The method of claim 1, wherein the first identification information is an IMEI number and the second identification information is an IMEI number.

7. The method of claim 1, further comprising:
receiving a second payment confirmation message from the second device, the second payment confirmation message being obtained by the second device from the payment server and including second payment-related information and third identification information;
identifying the third identification information from the second payment confirmation message;
obtaining fourth identification information from the second device through short distance communication between the first device and the second device;
determining that the third identification information is consistent with the fourth identification information; and
in response to the third identification information being consistent with the fourth identification information, verifying the payment by comparing at least a part of the second payment-related information with payment-related information previously stored in the first device.

8. A computer system for processing a mobile payment by a first device, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
receiving a first payment confirmation message from a second device, the first payment confirmation message being obtained by the second device from a payment server and including first payment-related information and first identification information;
identifying the first identification information from the first payment confirmation message;
obtaining second identification information from the second device through short distance communication between the first device and the second device;
determining that the first identification information is not consistent with the second identification information; and
in response to the first identification information being not consistent with the second identification information, providing a notification on the first device.

9. The system of claim 8, wherein at least a part of the first payment confirmation message has been encrypted with a first key of a key pair by the payment server, and the method further comprises decrypting at least a part of the first payment confirmation message with a second key of the key pair.

10. The system of claim 8, wherein the receiving the first payment confirmation message from the second device includes receiving the first payment confirmation message through at least one communication medium, wherein the at least one communication medium is selected from the group consisting of: scanning a machine-readable code presented on the second device, receiving short message communication, and receiving short distance communication between the first device and the second device.

11. The system of claim 8, wherein the at least one communication medium is a Near Field Communication (NFC) channel.

12. The system of claim 8, wherein the first identification information is an IMEI number and the second identification information is an IMEI number.

13. The system of claim 8, further comprising:
receiving a second payment confirmation message from the second device, the second payment confirmation message being obtained by the second device from the payment server and including second payment-related information and third identification information;
wherein the second payment confirmation message includes a time stamp indicating a time of the payment being made;
identifying the third identification information from the second payment confirmation message;
obtaining fourth identification information from the second device through short distance communication between the first device and the second device;
determining that the third identification information is consistent with the fourth identification information;
and in response to the third identification information being consistent with the fourth identification information, verifying the payment by determining the time stamp being within a time limit specified by the first device.

14. A computer program product, the computer program product comprising a computer readable storage medium having program instructions embodied therewith, the program instructions executable by a computer to cause the computer to:
receive a payment confirmation message from a second device, the payment confirmation message being obtained by the second device from a payment server and including payment-related information and first identification information;
identify the first identification information from the payment confirmation message;
obtain a second identification information from the second device through short distance communication between the first device and the second device; and
determine whether the first identification information is consistent with the second identification information;
wherein, in response to determining that the first identification information is not consistent with the second identification information, the program instructions further cause the computer to provide a notification on the first device; and
wherein, in response to determining that the first identification information is consistent with the second identification information, the program instructions further cause the computer to verify the payment.

15. The computer program product of claim 14, wherein verifying the payment comprises comparing at least a part of the payment-related information with payment-related information previously stored in the first device.

16. The computer program product of claim 14, wherein the payment confirmation message includes a time stamp indicating a time of the payment being made; and wherein verifying the payment comprises determining the time stamp being within a time limit specified by the first device.

17. The computer program product of claim 14, wherein at least a part of the payment confirmation message has been encrypted with a first key of a key pair by the payment server, and the method further comprises decrypting at least a part of the payment confirmation message with a second key of the key pair.

18. The computer program product of claim 14, wherein the receiving the payment confirmation message from the second device includes receiving the payment confirmation message through at least one communication medium, wherein the at least one communication medium is selected from the group consisting of: scanning a machine-readable code presented on the second device, receiving short message communication, and receiving short distance communication between the first device and the second device.

19. The computer program product of claim 14, wherein the at least one communication medium is a Near Field Communication (NFC) channel.

20. The computer program product of claim 14, wherein the first identification information is an IMEI number and the second identification information is an IMEI number.
